(19) United States
(12) Patent Application Publication
(10) Pub. No.: US 2015/0227534 A1
(43) Pub. Date: Aug. 13, 2015

(54) METHOD FOR PROCESSING DATA QUERY USING INFORMATION-CENTRIC NETWORK

(71) Applicant: ELECTRONICS AND TELECOMMUNICATIONS RESEARCH INSTITUTE, Daejeon (KR)

(72) Inventors: Hong Seok JEON, Daejeon (KR); Seung Hyun YOON, Daejeon (KR); Bhum Cheol LEE, Daejeon (KR)

(21) Appl. No.: 14/619,135

(22) Filed: Feb. 11, 2015

(30) Foreign Application Priority Data
Feb. 12, 2014 (KR) 10-2014-0016189

(51) Int. Cl. G06F 17/30; H04L 29/08

(52) U.S. Cl. CPC G06F 17/30091; H04L 67/1097; G06F 17/30864; G06F 17/30106; H04L 67/06

(57) ABSTRACT

A method for processing a query by accessing information by use of an Information-Centric Network (ICN) includes requesting, by a user device, a file by providing a local storage system with an identifier of the file; determining whether the local storage system stores the requested file; and generating, by the local gateway, an information request message including the identifier of the requested file if it is determined that the local storage system does not store the requested file, and providing the ICN with the generated information requested message. Accordingly, architecture expansion is easily achieved without a large scale update of information since there is no need to share information about a file list of each storage system as a whole, and a data query task is performed on a plurality of unspecified storage systems without establishing a one-to-one connection between end points of storage systems.

### CLAIM FOR PRIORITY

This application claims priority to Korean Patent Application No. 10-2014-0016189 filed on Feb. 12, 2014 in the Korean Intellectual Property Office (KIPO), the entire contents of which are hereby incorporated by reference.

### BACKGROUND

1. Technical Field

Example embodiments of the present invention relate in general to a technology for accessing information stored in a distributed manner, and more specifically, to a method for processing a query by accessing information using an Information-Centric Network (ICN).

2. Related Art

With the recent development of hardware technologies, there is an increasing use of various multimedia service-based devices, such as a smart phone and a tablet. Accordingly, users may easily access the Internet anywhere at any time. Such a paradigm shift in the device has brought about paradigm shift in the Internet use. In addition, even the use of Internet information has come to a rapid change to be focused on mobile or multimedia content when compared to the previous use of Internet information based on web pages.

Meanwhile, as a cloud computing service and a big data service have garnered a large amount of interest, various types of storage systems are suggested, for example, a distributed file system (DFS) for storing and managing files in a plurality of distributed servers or a database management system (DBMS) that is specialized in processing large scale data.

According to the convention technology for sending and answering a query about a file between storage systems in an environment in which the storage systems area connected to the Internet, an application program, which is the upper layer, is used to set a one-to-one connection to a storage system to which a query is sent about a file, to request a file and receive the requested file.

For example, in the case in which a storage system interoperates with a web server, a user may establish a session with a web server connected to a remote storage system, and request and receive a file through the web server.

However, such a method requires information about a file list managed by each storage system to be globally shared, and before requesting a file a connection needs to be set with a storage system subjected to the request That is, whenever a new storage system is connected to the Internet, information about a file list of the corresponding storage system needs to be globally shared, and since a file request process is performed between end points of storage systems at the upper layer, a session needs to be generated and maintained for each storage system.

In addition, such a method of transferring files on the upper layer has lower efficiency in transfer files when compared to the method for transferring files on the network layer.

### SUMMARY

Accordingly, example embodiments of the present invention are provided to substantially obviate one or more problems due to limitations and disadvantages of the related art.

Example embodiments of the present invention provide a method for processing a data query of a user using an Information Centric Network (ICN).

Example embodiments of the present invention also provide a method for allowing a user to easily access information stored in a local storage system and a remote storage system based on an identifier of information.

Example embodiments of the present invention also provide a method for enhancing the efficiency in transferring information by exchanging information on the network layer. In some example embodiments, a method for processing a data query using an Information-Centric Network (ICN) in accessing distributed information according to a request of a user device includes: requesting, by the user device, a file by providing a local storage system with an identifier of the file; determining whether the local storage system stores the requested file; and generating, by the local gateway, an information request message including the identifier of the requested file if it is determined that the local storage system does not store the requested file, and providing the ICN with the generated information requested message.

The method may, include providing, by the local storage system, the user device with the requested file if it is determined that the local storage system stores the requested file. The method may further include requesting, by a remote gateway having received the information request message through the ICN, the requested file from a remote storage system based on the identifier of the requested file.

The method may further include: sending, by the remote storage system, the requested file to the remote gateway according to the request of the remote gateway; and generating, by the remote gateway having received the requested file, an information response message including the requested file, and transferring the generated information response message to the local gateway.

The method may further include: transferring, by the local gateway having received the information response message, the requested file included in the information response message to the local storage system; and transferring, by the local storage system having received the requested file, the requested file to the user device.

The local storage system may be a database system to which a database management system (DBMS) is applied.

The local gateway may interoperate with the DBMS.

The local, storage system may be a distributed storage system.

The local gateway may interoperate with a metadata server of the distributed storage system, or operate as a data server of the distributed storage system.

The requested file may be video and image data used in a Closed Circuit TeleVision (CCTV).

In other example embodiments, a method for processing a data query using an Information-Centric Network (ICN) in accessing distributed information according to a request of a user device includes: receiving, by a remote gateway, an information request message including an identifier of a file through the Information-Centric Network (ICN); and requesting the file corresponding to the identifier of the file from a remote storage system.

The method may further include: sending, by the remote storage system, the requested file to the remote gateway according, to the request of the remote gateway; and generating, by the remote gateway having received the requested file, an information response message including the file, and transferring the generated information response message to a local gateway through the ICN.

The method may further include: transferring, by the local gateway having received the information response message, the file included in the information response message to a local storage system; and transferring, by the local storage system having received the file, the file to the user device.

As is apparent from the above, the method for processing a data query in accordance with an exemplary embodiment of the present invention can facilitate architecture expansion without a large scale update of information since there is no need to share information about a file list of each storage system as a whole.

In addition, a data query task can be performed on a plurality of unspecified storage systems without establishing a one-to-one connection between end points of storage systems.

In addition, the file transfer is performed directly on the network layer, so that the transfer performance can be improved.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating a data query process in accordance with exemplary embodiments of the present invention;

FIG. 2 is a flowchart showing a data query process in accordance with exemplary embodiments of the present invention;

FIG. 3 is a flowchart showing a data query process in accordance with exemplary embodiments of the present invention in detail;

FIG. 4 is a conceptual diagram illustrating a case in which a storage system in accordance with exemplary embodiments of the present invention is a database system;

FIG. 5 is a conceptual diagram illustrating a case in which a storage system in accordance with an exemplary embodiment of the present invention is a distributed storage system;

FIG. 6 is a conceptual diagram illustrating a case in which a storage system in accordance with another exemplary embodiment of the present invention is a distributed storage system; and

FIG. 7 is a conceptual diagram illustrating a case in which storage systems in accordance with exemplary embodiments of the present invention store images photographed at different areas.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings.

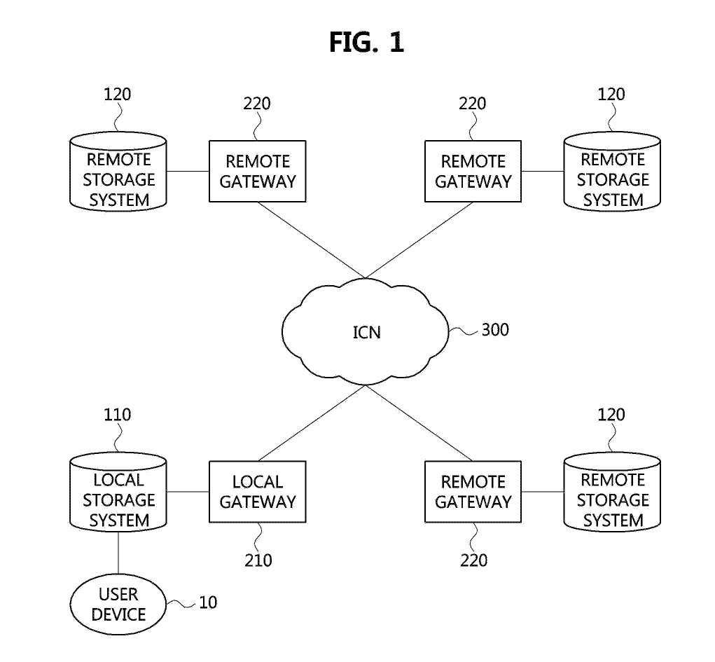

FIG. 1 is a conceptual diagram illustrating a data query process in accordance with exemplary embodiments of the present invention.

Referring to FIG. 1, a data query processing in accordance with, an exemplary embodiment of the present invention is achieved by interoperation among a user device 10, storage systems 110 and 120, gateways 210 and 220 and an Information-Centric Network (ICN).

The user device 10 may be provided using a computer and a portable terminal used by a user, and hardware and an application program installed on hardware. A user may access information data or a file using a query through the user device 10.

The storage systems 110 and 120 may be provided using a file system or a database, and the file system includes a distributed file system, such as Google File System (GFS), Hadoop Distributed File System (I-IDFS) and OpenStack Swift. The storage systems 110 and 120 may be divided into a local storage system 110 and a remote storage system 120. The local storage system 110 represents a storage system allowing a direct access of the user device 10 not through the gateway 210 or network, and the remote storage system 120 represents a storage system remotely located and allowing access of the user device 10 through the gateway 210 and network.

The gateways 210 and 220 exist on the storage systems 110 and 120, respectively, and serve to connect the storage systems 110 and 120 to the ICN 300. The gateways 210 and 220 may exist in the storage systems 110 and 120, or may exist separately from the storage systems 110 and 120. The gateways 210 and 220 may be divided into a local gateway 210 and a remote gateway 220. The local gateway 210 is connected to the local storage system 110, and the remote gateway 220 is connected to the remote storage system 120.

The ICN 300 represents an Internet network having an architecture in which only the identifier of information is used in searching for information desired by a user and providing the found information. The information may represent data or a file.

The existing Internet architecture using an IP based client-server model complies with a one-to-one transmission paradigm, in which a connection is established between end nodes joining communication and an IP data packet is transmitted between the nodes for which the connection is established. Accordingly, the existing Internet architecture has limitations in terms of scalability and security.

In comparison with the existing Internet architecture, the ICN 300 changes the current paradigm focused on “where”, such as an address, a server and a host, to emphasize “what”, that is, information important to a user and an application. That is, the ICN 300 assigns a unique identifier or a name to information, instead of designating a location, such as an IP address, considering information as an optimum independent entity.

Accordingly, a user in the ICN 300 provides the ICN 300 with an identifier of desired information instead of searching for a server or host having information and requesting the information, and the ICN 300 may search for the information using the identifier and transfer the found information to the user.

For example, a Content Centric Network (CCN) technology is one of the ICN technologies that use a hierarchical information identifier.

The information identifier of the CCN is constructed in a hierarchical manner similar to URL, but does not include address information different from URL. The CCN complies with a Request-Response communication module. A subject requesting information generates an INTEREST packet representing an information request message, and transmits the generated INTEREST packet to the CCN. The INTEREST packet includes an identifier of information desired by the information request subject. The CCN having received the INTEREST packet transmits the INTEREST packet to a holder of the information. The information holder, upon receiving of the INTEREST packet, generates a DATA packet as an information response message, and sends the DATA packet. The DATA packet includes the information desired by the information requesting subject. The DATA packet may be transmitted to the subject having requested the information.

In the following description, it may be understood that a certain file may represent a file requested by a user, or a file corresponding to a file identifier.

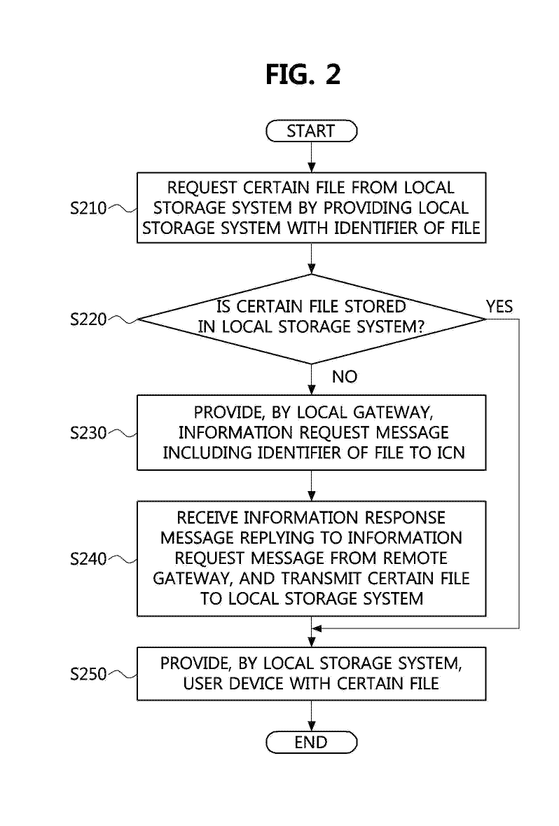

FIG. 2 is a flowchart showing a data query process in accordance with exemplary embodiments of the present invention.

Referring to FIG. 2, the following description, will be made in relation to a procedure of operation of the local storage system 110 and the local gateway 210 performed for a user to request and acquire a desired file in a distributed data storage environment.

The user device 10 may request a certain file from the local storage system 110 by providing the local storage system 110 with an identifier of the desired file (S210).

It is determined whether the local storage system 110 stores the certain file (S220).

The user device 10 may receive the certain file from the local storage system 110 if it is determined that the local storage system 110 stores the requested file (S250).

The local gateway 210 generates an information request message including the identifier of the file if it is determined that the local storage system 110 does not store the certain file, and provides the ICN 300 with the generated information request message (S230).

That is, if the local storage system 110 does not store a file desired by a user, or lacks a certain type of file desired by a user and an additional request for the file needs to be requested, the local storage system 110 may request the certain file from the local gateway 210 by providing an identifier of the file. When a database system is used as the local storage system 110, a Database Management System (DBMS) may request the certain file by providing the local gateway 210 with an identifier of the file.

The local gateway 210 may generate the information request message including the identifier of the file, and transmit the generated information request message to the ICN 300. In the case in which Content Centric Networking (CCN) is used as the ICN, an INTEREST packet is used as the information request message, and the INTEREST packet may include the identifier of the file desired by the user.

The local gateway 210 may receive an information response message replying to the information request message. The information response message includes the certain file requested by the user. When the CCN technology is used as the ICN technology, a DATA packet may be used as the information response message. Accordingly, the information response message replying to the information request message may be received from the remote gateway 220 through the ICN, so that the certain file may be transmitted to the local storage system 110 (S240).

The local gateway 210 may transmit the received certain file to the local storage system 110. If a database system is used as the local storage system 110, the local gateway 210 may transmit the received certain file to a DBMS.

Accordingly, the local storage system 110 may transmit the received certain file to the user device 10 (S250). If a database system is used as the local storage system 110, a DBMS may transmit the received certain file to the user device 10.

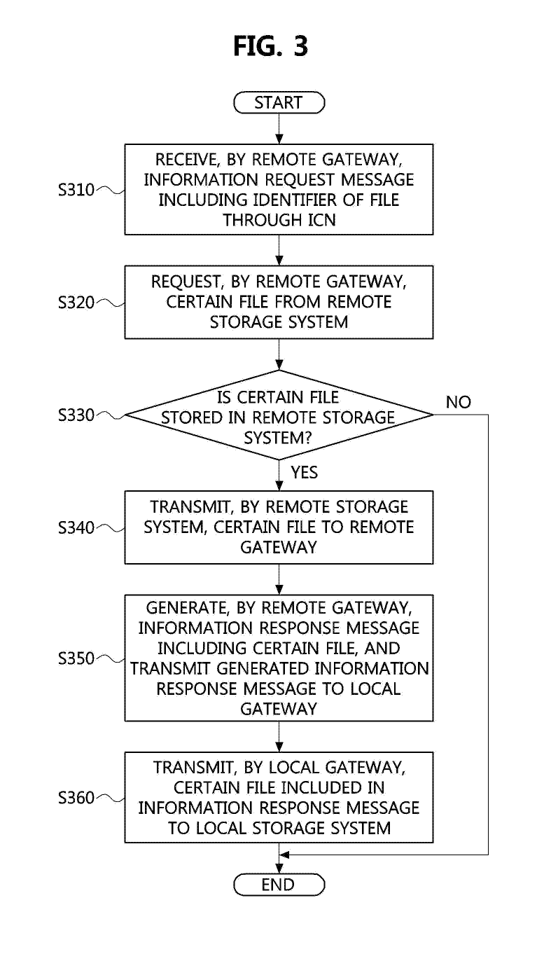

FIG. 3 is a flowchart showing a data query process in accordance with exemplary embodiments of the present invention in detail.

Referring to FIG. 3, the following description will be made in relation to a procedure of an operation of the local storage system 110 and the local gateway 220 performed for a user to acquire a desired file in a distributed data storage environment.

The remote gateway 220 receives an information request message including an identifier of a file through the ICN 300 (S310). When the CCN technology is used as the ICN, the remote gateway 220 may receive an INTEREST packet.

The remote gateway 220 requests the certain file from the remote storage system 120 using the file identifier included in the information request message (S320). That is, the remote gateway 220 having received the information request message through the ICN 300 may request the certain file based on the identifier of the file. When a database system is used as the remote storage system 120, the remote gateway 220 may request the file from a DBMS using the identifier of the file included in the information request message.

The remote storage system 120 may determine whether the remote storage system 120 stores the requested file (S330).

If the remote storage system 120 stores the requested file, the remote storage system 120 transmits the file to the remote gateway 220 (S340). If the remote storage system 120 does not store the requested file, the procedure is completed. When a database system is used as the remote storage system 120, the DBMS transmits the requested file to the remote gateway 220.

The remote gateway 220 sends the ICN 300 the received file in an information response message. When a CCN technology is used as the ICN, the remote gateway 220 sends a CCN the received file in a DATA packet. In this manner, the local gateway 210 receives the requested file from the ICN 300 (5350).

In addition, the local gateway 210 having received the information response message may transmit the file included in the information response message to the local storage system 110 (S360), and the local storage system 110 having received the file may transmit the file to the user device 10.

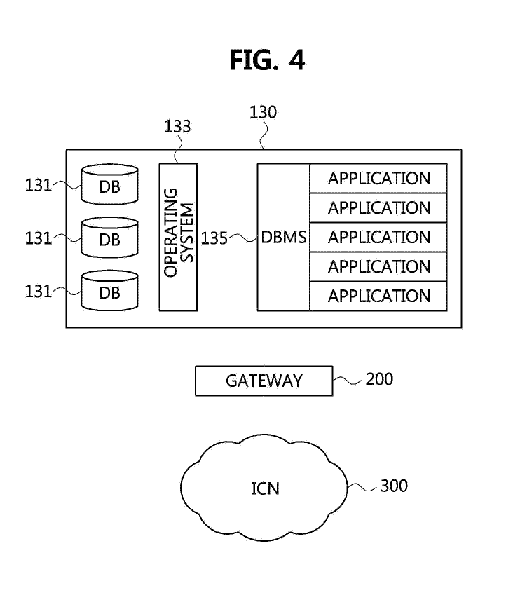

FIG. 4 is a conceptual diagram illustrating a case in which a storage system in accordance with exemplary embodiments of the present invention is a database system.

Referring to FIG. 4, a database system 130 may be used as a storage system. The database system 130 may include a plurality of databases 131, an operating system 133 and a DBMS 135. As shown in FIG. 4, the gateway 200 is connected to the DBMS 135, and the DBMS 135 serves as a subject requesting a certain file from the gateway 200 when the certain file desired by the user does not exist in the database 131. That is, the gateway 200 may transmit an identifier of the certain file desired by the user to the ICN 300.

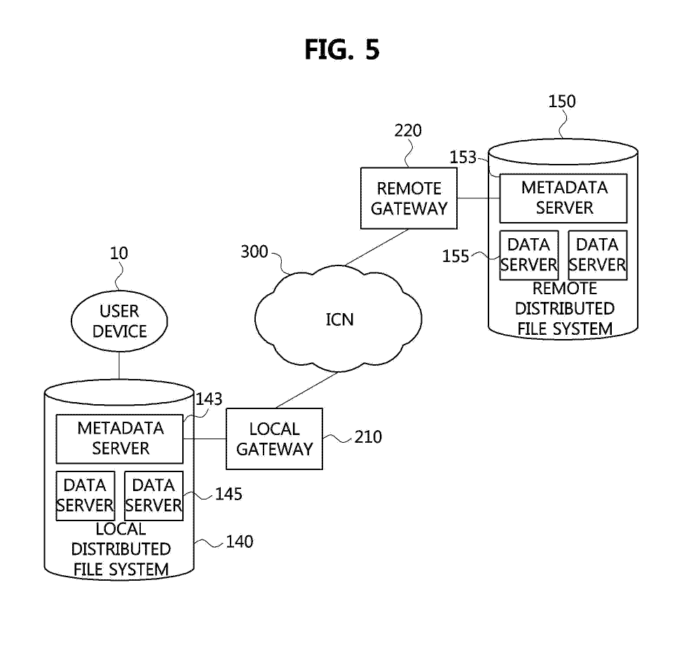

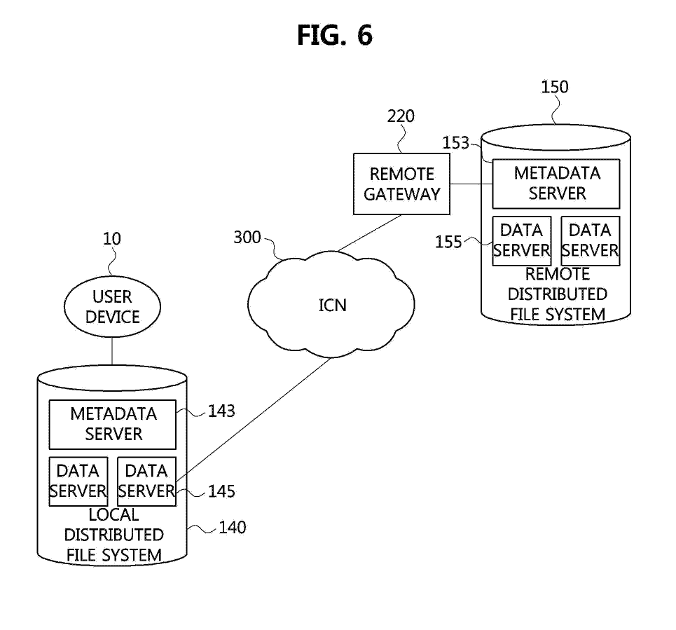

FIG. 5 is a conceptual diagram illustrating a case in which a storage system in accordance with an exemplary embodiment of the present invention is a distributed storage system, and FIG. 6 is a conceptual diagram illustrating a case in which a storage system in accordance with another exemplary embodiment of the present invention is a distributed storage system.

Referring to FIGS. 5 and 6, when a Distributed File System (DFS) is used as a storage system in accordance with an exemplary embodiment of the present invention, a user device 10 may request a file from a remote storage system 120 through a gateway.

The distributed file system includes a metadata server to manage metadata and a data server to store actual data. The metadata includes identifier information of the data server, and the metadata server may be provided using Master of Google File System and Namenode of Hadoop distributed file system. In addition, Chunkserver of Google File System and Datanode of Hadoop distributed file system may serve as data servers.

Referring to FIG. 5, first, the gateways 210 and 220 are connected to metadata servers of distributed file systems, and a procedure of the user device 10 requesting a file from a remote distributed file system 150 is as follows.

The user device 10 queries a metadata server 143 of a local distributed file system 140 about meta information about a certain file desired by a user.

The metadata server 143 of the local distributed file system 140 checks that the requested certain file is not stored in data servers 145 managed by the metadata server 143, and reports to the user device 10 that a request needs to be made of the local gateway 210 for the certain file.

The user device 10 requests the certain file by providing an identifier of the certain file through the local gateway 210.

The local gateway 210 generates an information request message including the identifier of the file, and transmits the generated information request message to the ICN 300. When the CCN technology is used as the ICN, the local gateway 210 uses an INTEREST packet as the information request message, and the INTEREST packet includes the identifier of the file.

The information request message is transmitted to the remote gateway 220 of the remote distributed file system 150 storing the certain information, and the remote gateway 220 requests metadata of the file corresponding to the file identifier included in the information request message from the metadata server 153.

The metadata server 153 of the remote distributed file system 150 transmits the requested metadata to the remote gateway 220.

The remote gateway 220 checks a data server 155 of the remote distributed file system 150 that stores the certain file, through the received metadata, and requests the certain file from the data server 155.

The data server 155 of the remote distributed file system 150 transmits the requested certain file to the remote gateway 220.

The remote gateway 220 generates an information response message to deliver the received certain file, and transmits the generated information response message to the ICN 300. When the CCN technology is used as the ICN technology, the remote gateway 220 may use a DATA packet as the information response message.

The local gateway 210 receives the information response message, and transmits the certain file included in the information response message to the user through the local distributed file system 140.

Referring to FIG. 6, the data server 145 of the local distributed file system 140 serves as a local gateway 210, and a procedure of the user device 10 requesting a file from a remote distributed file system 150 is as follows.

The user device 10 queries a metadata server 143 of a local distributed file system 140 about meta information about a certain file desired by a user.

The metadata server 143 of the local distributed file system 140 checks that the requested certain file is not stored in data servers 145 managed by the metadata server 143, and transmits metadata representing the data server 145 serving as the local gateway 210 in the local distributed file system 140 to the user.

The user requests the file from the data server of the local distributed file system 140 specified on the received meta data.

The data server 145 serving as the local gateway 210 in the local distributed file system 140 generates an information request message including the identifier of the file, and transmits the generated information request message to the ICN 300. The ICN transmits the information request message based on an identifier of the file. When the CCN technology is used as the ICN, the data server 145 serving as the local gateway 210 in the local distributed file system 140 uses an INTEREST packet as the information request message, and the INTEREST packet includes the identifier of the file.

The information request message is transmitted to the remote gateway 220 of the remote distributed file system 150 storing the certain file, and the remote gateway 220 requests metadata of a file corresponding to the file identifier included in the information request message from the metadata server 153.

The metadata server 153 of the remote distributed file system 150 transmits the requested metadata to the remote gateway 220.

The remote gateway 220 checks a data server 155 of the remote distributed file system 150 that stores the certain file, through the received metadata, and requests the certain file from the data server 155.

The data server 155 of the remote distributed file system 150 transmits the requested certain file to the remote gateway 220.

The remote gateway 220 generates an information response message to deliver the received certain file, and transmits the generated information response message to the ICN 300. When the CCN technology is used as the ICN technology, the remote gateway 220 may use a DATA packet as the information response message.

The data server 145 serving as the local gateway 210 in the local distributed file system 140 receives the information response message, and transmits the certain file included in the information response message to the user device 10. The user may be not aware that the certain file requested by the user is transmitted from the remote distributed file system 150.

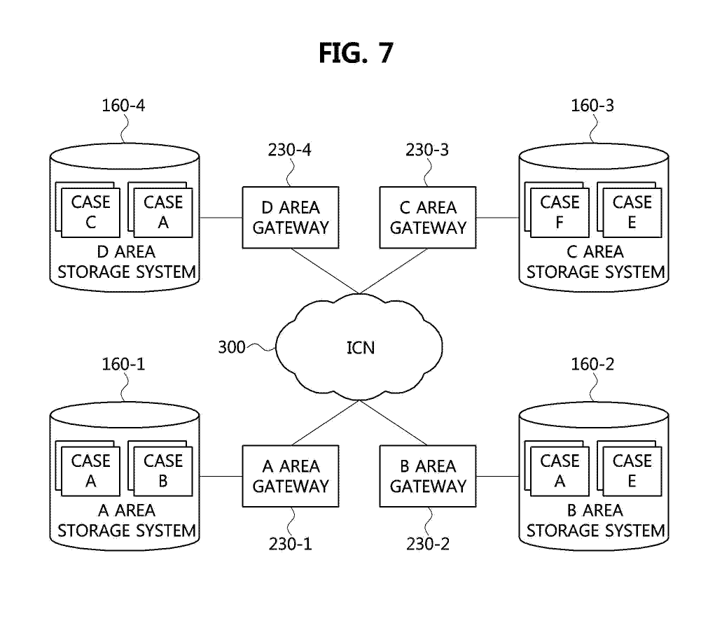

FIG. 7 is a conceptual diagram illustrating a case in which storage systems in accordance with exemplary embodiments of the present invention store images photographed at different areas.

FIG. 7 shows an environment in which storage systems storing images photographed through video recorders, such as a CCTV, are regionally distributed and connected to each other through the ICN 300.

Referring to FIG. 7, the storage systems manage respective pieces of image data that photographed in respective areas. The storage systems store the respective image data that are classified into cases. For example, each image data may be named according to accident cases, such as “kidnapping” and “accident at apartment roof” and managed.

The storage systems of the respective areas are connected to the ICN 300 through a gateway, to form a single network file system environment.

In the environment shown in FIG. 7, a procedure of a user requesting an image data from the remote storage system 120 is as follows.

First, a A area storage system 160-1 stores images about ‘case A’ and ‘case B’, a B area storage system 160-2 stores images about ‘case A’ and ‘case E’, a C area storage system 160-3 stores images about ‘case E’ and ‘case F’, and a D area storage system 160-4 stores images about ‘case A’ and ‘case C’.

For example, in order to make an accurate decision on an accident circumference corresponding to ‘case A’ by using the user device 10 located in area A, a user may search for image data named ‘case A’ in the A area storage system 160-1 and perform a comparative analysis on the image data comparison/analysis.

However, when the A area storage system 160-1 does not store sufficient amount of image data corresponding to type ‘case A’, the user may request image data corresponding to type ‘case A’ from the storage systems of other areas.

In detail, an A area gateway 230-1 generates an information request message including an identifier of the image data about ‘case A’, and transmits the generated information request message to the ICN 300. When the CCN technology is used as the ICN, the A area gateway 230-1 uses an INTEREST packet as the information request message, and the INTEREST packet includes the identifier of the image data about ‘case A’.

The information request message is transmitted to a B area gateway 230-2 and a D area gateway 230-4 of the B area storage system 160-2 and the D area storage system 160-4 that have the image data about ‘case A’, through the ICN 300.

In the environment shown in FIG. 7, a procedure of the user receiving the image data from the remote storage system 120 is as follows.

The B area gateway 230-2 and the D area gateway 230-4 having received the information request message check that the information request message requests image data about ‘case A’.

The B area gateway 230-2 and the D area gateway 230-4 each search for the image data of the type ‘case A’ in the B area storage system 160-2 and the D area storage system 160-4 connected to the B area gateway 230-2 and the D area gateway 230-4, respectively, and each generate an information response message to deliver the image data, and transmit the generated information response message to the ICN 300. When the CCN technology is used as the ICN technology, the B area gateway 230-2 and the D area gateway 230-4 use a DATA packet as the information response message.

The A area gateway 230-1 receives the information response message from the ICN 300, and transmits the image data included in the information response message to the user device 10.

Accordingly, the user may accurately decide whether the image photographed in A area corresponds to type ‘case A’ accident based on the received image data about ‘case A’, and take an appropriate action depending on the decision.

The method for processing a data query in accordance with an exemplary embodiment of the present invention can facilitate architecture expansion without a large scale update of information since there is no need to share information about a file list of each storage system as a whole.

In addition, a data query task can be performed on a plurality of unspecified storage systems without establishing a one-to-one connection between end points of storage systems.

In addition, the file transfer is performed directly on the network layer, so that the transfer performance can be improved.

While the example embodiments of the present invention and their advantages have been described in detail, it should be understood that various changes, substitutions and alterations may be made herein without departing from the scope of the invention.

What is claimed is:

1. A method for processing a data query using an Information-Centric Network (ICN) in accessing distributed information according to a request of a user device, the method comprising:
requesting, by the user device, a file by providing a local storage system with an identifier of the file;
determining whether the local storage, system stores the requested file; and
generating, by the local gateway, an information request message including the identifier of the requested file if it is determined that the local storage system does not store the requested file, and providing the ICN with the generated information requested message.

2. The method of claim 1, comprising providing, by the local storage system, the user device with the requested file if it is determined that the local storage system stores the requested file.

3. The method of claim 1, further comprising requesting, by a remote gateway having received the information request message through the ICN, the requested file from a remote storage system based on the identifier of the requested file.

4. The method of claim 3, further comprising:
sending, by the remote storage system, the requested file to the remote gateway according to the request of the remote gateway; and
generating, by the remote gateway having received the requested file, an information response message including the requested file, and transferring the generated information response message to the local gateway.

5. The method of claim 4, further comprising:
transferring, by the local gateway having received the information response message, the requested file included in the information response message to the local storage system; and
transferring, by the local storage system having received the requested file, the requested file to the user device.

6. The method of claim 1, wherein the local storage system is a database system to which a database management system (DBMS) is applied.

7. The method of claim 1, wherein the local gateway interoperates with the DBMS.

8. The method of claim 1, wherein the local storage system is a distributed storage system.

9. The method of claim 8, wherein the local gateway interoperates with a metadata server of the distributed storage system, or operates as a data server of the distributed storage system.

10. The method of claim 1, wherein the requested file is video and image data used in a Closed Circuit TeleVision (CCTV).

11. A method for processing a data query using an Information-Centric Network (ICN) in accessing distributed information according to a request of a user device, the method comprising:
receiving, by a remote gateway, an information request message including an identifier of a file through the Information-Centric Network (ICN); and
requesting the file corresponding to the identifier of the file from a remote storage system.

12. The method of claim 11, further comprising:
sending, by the remote storage system, the requested file to the remote gateway according to the request of the remote gateway; and
generating, by the remote gateway having received the requested file, an information response message including the file, and transferring the generated information response message to a local gateway through the ICN.

13. The method of claim 12, further comprising:
transferring, by the local gateway having received the information response message, the file included in the information response message to a local storage system; and
transferring, by the local storage system having received the file, the file to the user device.

14. The method of claim 11, wherein the remote storage system is a database system to which a database management system (DBMS) is applied.

15. The method of claim 14, wherein the remote gateway interoperates with the DBMS.

16. The method of claim 11, wherein the remote storage system is a distributed storage system.

17. The method of claim 16, wherein the remote gateway interoperates with a metadata server of the distributed storage system.

18. The method of claim 11, wherein the file is video and image data used in a Closed Circuit TeleVision (CCTV).
